(19) United States
(12) Patent Application Publication
(10) Pub. No.: US 2012/0006809 A1
(43) Pub. Date: Jan. 12, 2012

(54) SUBLIMATION CRUCIBLE WITH EMBEDDED HEATER ELEMENT

(75) Inventors: Pavel Sergey Kobyakov, Fort Collins, CO (US); Walajabad S. Sampath, Fort Collins, CO (US); Kevin Eugene Walters, Milliken, CO (US)

(73) Assignee: COLORADO STATE UNIVERSITY RESEARCH FOUNDATION, Fort Collins, CO (US)

(21) Appl. No.: 13/167,479

(22) Filed: Jun. 23, 2011

Related U.S. Application Data
(60) Provisional application No. 61/357,890, filed on Jun. 23, 2010.

(51) Int. Cl. H05B 3/06; B28B 1/087; C04B 35/653

(52) U.S. Cl. 219/542; 264/332; 264/71

(57) ABSTRACT

Systems, apparatus and methods for in-line evaporative deposition are described herein that include a nickel chromium wire based heating system that can reach desired operating temperatures while providing opportunities for improved temperature uniformity and energy usage. In some embodiments, an apparatus includes a base member configured to be used as a sublimation crucible and the base member defines a channel in a surface of the base member. A first layer of electrically insulating material is disposed within the channel and has a substantially uniform thickness. A heater coil is disposed within the channel such that the first layer of electrically insulating material is disposed between the heater coil and the surface of the base. A second layer of electrically insulating material is disposed on the heater coil such that the heater coil is disposed between the first layer of electrically insulating material and the second layer of electrically insulating material.

### CROSS REFERENCE TO RELATED APPLICATIONS

This application claims priority to and the benefit of U.S. Provisional Patent Application No. 61/357,890, filed Jun. 23, 2010, entitled “Advanced Heated Pocket Deposition,” which is hereby incorporated herein by reference in its entirety.

### FIELD OF THE INVENTION

The present invention relates to systems, apparatus and methods for conductive heating for a sublimation source. In particular, but not by way of limitation, the present invention relates to systems, apparatus and methods for embedding an electric heating coil in a graphite crucible.

### BACKGROUND OF THE INVENTION

Evaporative deposition is a physical deposition process that can be used for various thin film deposition applications, including use in consumer electronics (from integrated circuit fabrication to cell phone, computer and television display coatings), optics (e.g., coating glass), microparticle fabrication, photovoltaic fabrication, as well as other applications.

Typical known evaporative deposition systems can be used for closed space sublimation (CSS) or heated pocket deposition (HPD) processes. Such evaporative deposition systems include a source (or crucible) that contains a deposition material. The source is heated sufficiently such that the deposition material reaches a sublimation point. At the sublimation point, particles of the deposition material can separate and enter a vapor pocket of the crucible, and condense across the surface of the substrate forming a thin film.

To heat the source to a sufficient temperature for sublimation, known evaporative deposition systems commonly use a heating method that uses high intensity infrared (IR) bulbs. Due to the radial emission of energy from the IR bulbs, controlling the energy that is not directly incident on the crucible surface is not trivial and can lead to inefficient power use and potential heating of the surrounding shielding and support structures.

Although present devices are functional, they are not sufficiently accurate or otherwise satisfactory. Accordingly, a system, apparatus and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In some embodiments, an apparatus includes a base member configured to be used as a sublimation crucible and the base member defines a channel in a surface of the base member. A first layer of electrically insulating material is disposed within the channel and has a substantially uniform thickness. A heater coil is disposed within the channel such that the first layer of electrically insulating material is disposed between the heater coil and the surface of the base. A second layer of electrically insulating material is disposed on the heater coil such that the heater coil is disposed between the first layer of electrically insulating material and the second layer of electrically insulating material.

In some embodiments, a method of making a sublimation crucible includes forming a channel in a surface of a sublimation crucible. A first volume of electrically insulating material is poured into the channel. A mold is pressed into the channel such that the first volume of electrically insulating material forms a shape of the mold. A heater coil is placed into the channel such that the molded electrically insulating material is disposed between surface of the sublimation crucible and the heater coil. A second volume of the electrically insulating material is poured over the heater coil such that a layer of the second volume of electrically insulating material is formed over the heater coil.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is side cross-sectional views of an exemplary prior art evaporative deposition system that can be used for thin film deposition during photovoltaic module production.

FIG. 2 is a sectional view orthogonal of the cross-sectional view of the prior art evaporative deposition system of FIG. 1.

FIG. 3 is a bottom perspective view of a portion of an evaporative deposition system according to an embodiment.

FIG. 4 is a bottom perspective view of a crucible of the evaporative deposition system of FIG. 3.

FIG. 5A is a plan view of the bottom surface of the crucible of the evaporative deposition system of FIG. 4; and FIG. 5B is a cross-sectional view taken along line 5B-5B in FIG. 5A.

FIG. 6 is a plan view of the bottom surface of the crucible of FIG. 4 shown with a layer of electrically conductive material disposed within a channel of the crucible.

FIG. 7A is an exploded perspective view of the crucible of FIG. 4 and a heater element of the evaporative deposition system of FIG. 3.

FIG. 7B is a cross-sectional view of a portion of the crucible, heater element and a first layer of material of the evaporative deposition system of FIG. 3.

FIG. 8 is a plan view of the bottom surface of the crucible of FIG. 4, heater coil of FIG. 7A and a layer of electrically conductive material disposed over the heater coil.

FIG. 9 is a bottom perspective view of a crucible of an evaporative deposition system according to another embodiment.

FIG. 10 is a top perspective view of a crucible of the evaporative deposition system of FIG. 9.

FIG. 11 is a plan view of a bottom surface of the crucible of FIG. 9.

FIG. 12 is a side view of the crucible of FIG. 9.

FIG. 13 is a cross-sectional view taken along line A-A in FIG. 11.

FIG. 14 is a plan view of a top surface of the crucible of FIG. 9.

FIG. 15 is an end plan view of the crucible of FIG. 9.

FIG. 16 is a cross-sectional view taken along line B-B in FIG. 12.

FIG. 17 is a cross-sectional view of a crucible according to another embodiment.

FIG. 18 is a flowchart of a method of making an evaporative deposition system according to an embodiment.

FIG. 19 is a table illustrating computational fluid dynamics computation temperatures versus experimental temperatures at various source locations associated with an example test of a crucible according to an embodiment.

FIG. 20 illustrates temperature monitor locations associated with an example test of a crucible according to an embodiment.

FIG. 21 illustrates steady state temperature contours associated with an example test of a crucible according to an embodiment.

### DETAILED DESCRIPTION

Systems, apparatus and methods for in-line evaporative deposition are described herein that include an electrical heater element (e.g., coil) based heating system that can reach desired operating temperatures while providing opportunities for improved temperature uniformity and energy usage. For example, a sublimation crucible is described herein that can include a heating coil embedded within the sublimation crucible. In some embodiments, a substrate heater can include a heating element embedded within the substrate heater. In some embodiments, the heating coil can be formed with nickel chromium (NiCr). A thermally conductive, electrically insulating material (e.g., a ceramic material) can be used to insulate and embed the heater coil within a channel defined within the sublimation crucible. The systems, apparatus and methods described herein can allow for conductive heating of the sublimation crucible and/or a substrate heater, with improved efficiency of the heating unit and heat distribution. Utilizing a conductive heating method can also reduce the complexity of the radiation shielding surrounding the crucible (and/or substrate heater) and the heating hardware. In some embodiments, an embedded heater element s described herein can be used to improve temperature uniformity of a sublimation crucible and/or a substrate heater by varying the location of the heating element within the crucible or substrate heater.

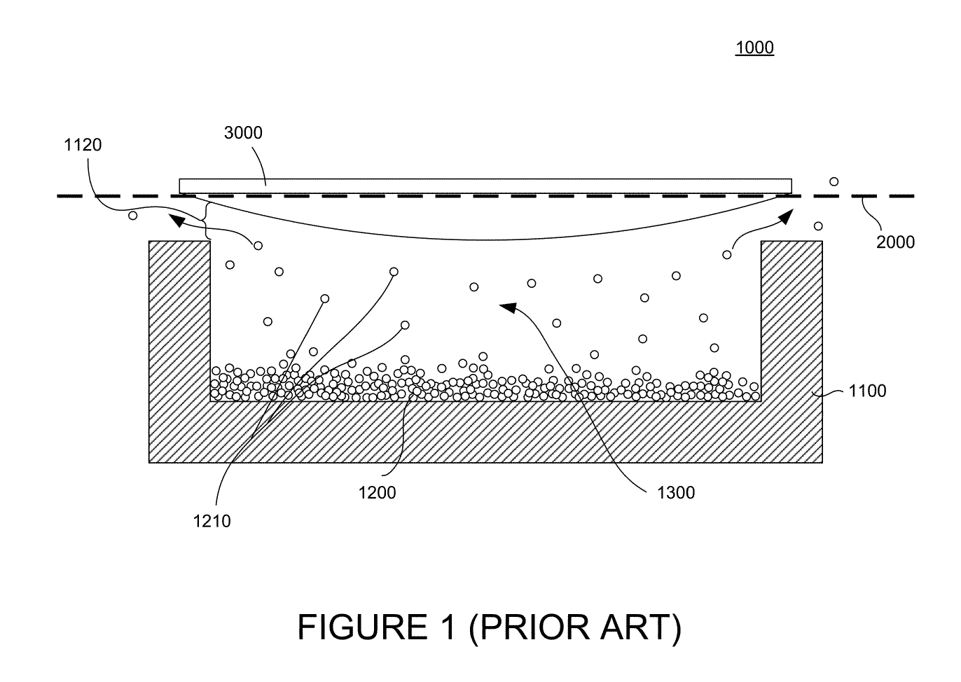

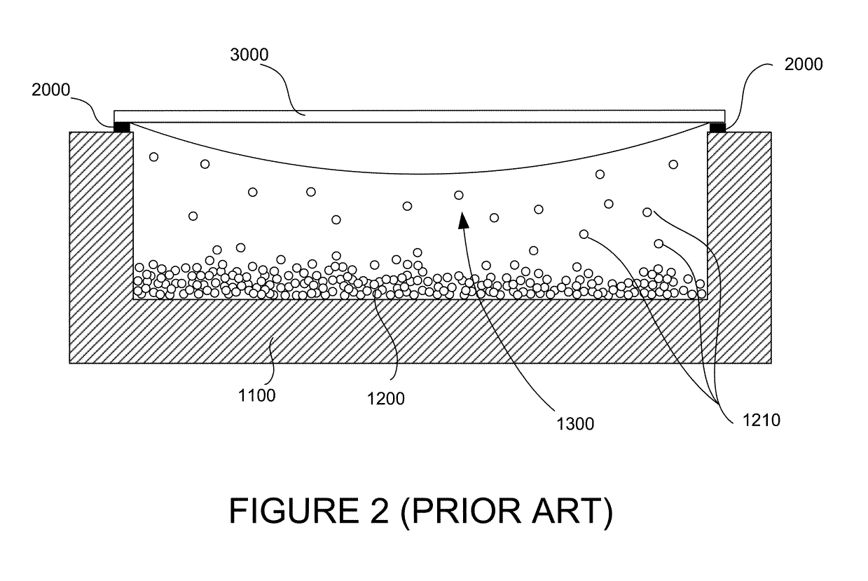

For purposes of explanation, FIGS. 1 and 2 provide sectional views of an exemplary evaporative deposition system 1000 that can be used, for example, for thin film deposition during photovoltaic module production. This evaporative deposition system 1000 could be used for a closed space sublimation (CSS) or heated pocket deposition (HPD) process. The evaporative deposition system 1000 shown in FIGS. 1 and 2 includes a source (or crucible) 1100 that contains a deposition material 1200. The source 1100 is disposed within a vacuum chamber (not shown). In FIG. 1, a substrate transport 2000 is shown, which is configured to carry and position a substrate 3000 over the source 1100. FIG. 2, which is a sectional view orthogonal to that of FIG. 1, shows the substrate transport 2000 holding the sides of substrate 3000 carrying the substrate into (or out of) the paper.

In operation, the source 1100 is heated sufficiently such that the deposition material 1200 reaches a sublimation point. At the sublimation point, particles 1210 of the deposition material 1200 separate and enter a vapor pocket 1300. Optimally, the particles 1210, or vapor 1210, will travel through the vapor pocket 1300 and condense evenly across the surface of substrate 3000 forming a thin film.

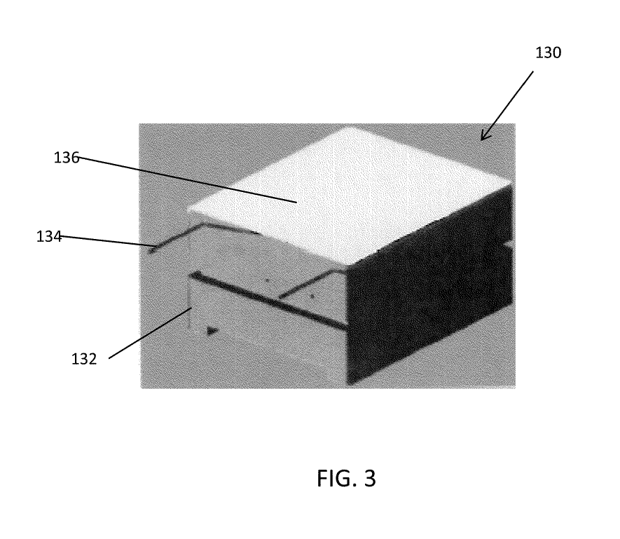

FIGS. 3-8 illustrate a bottom perspective view of a portion of an evaporative deposition system 130 according to an embodiment. The evaporative deposition system 130 (also referred to herein as “deposition system” or “system”) includes a sublimation crucible 132 (also referred to herein as “crucible” or “base” or “source”), an electrical heating element 134 and cover 136. The evaporative deposition system 130 can be used, for example, for closed space sublimation (CSS) or a heated pocket deposition (HPD) process as described above. The sublimation crucible 132 can be formed, for example, with a graphite material, or other suitable material as known in the art and can contain a deposition material as described above. The crucible 132 can also include a vapor pocket in which the deposition material can enter as it separates when heated to a sublimation point.

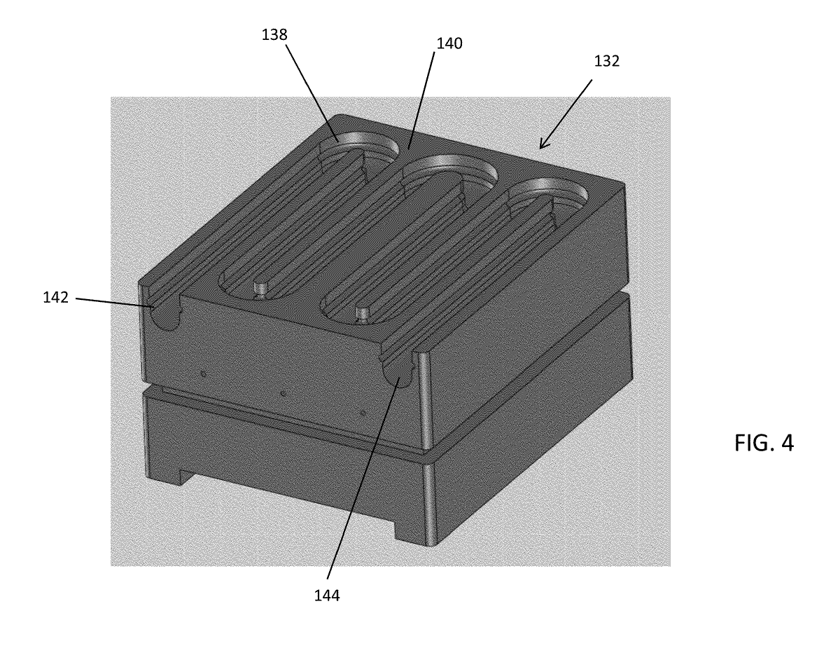

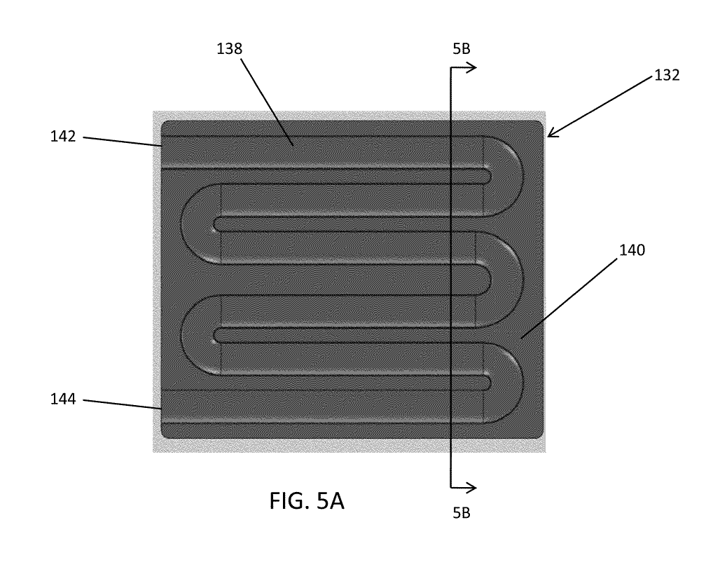

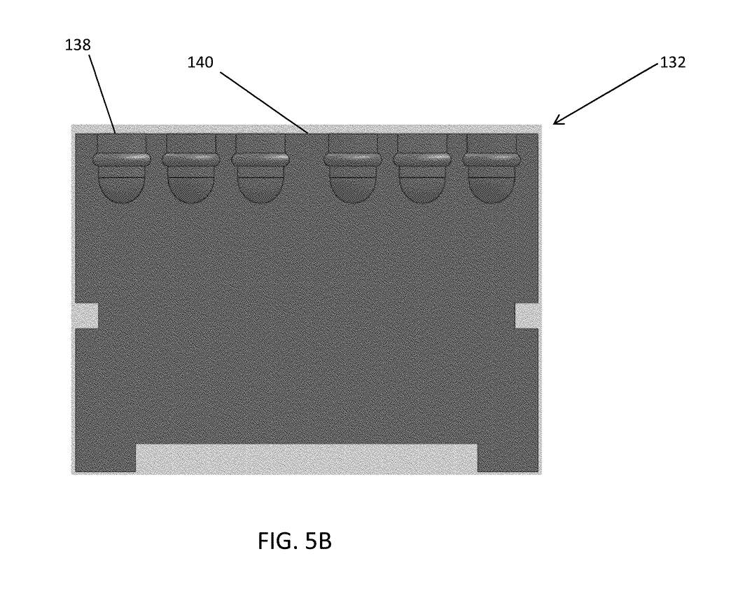

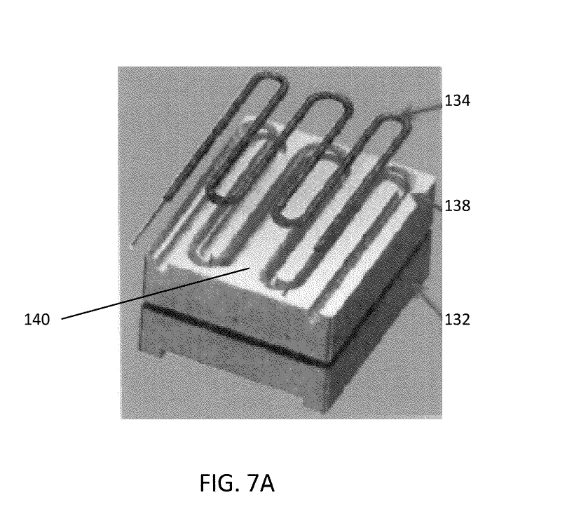

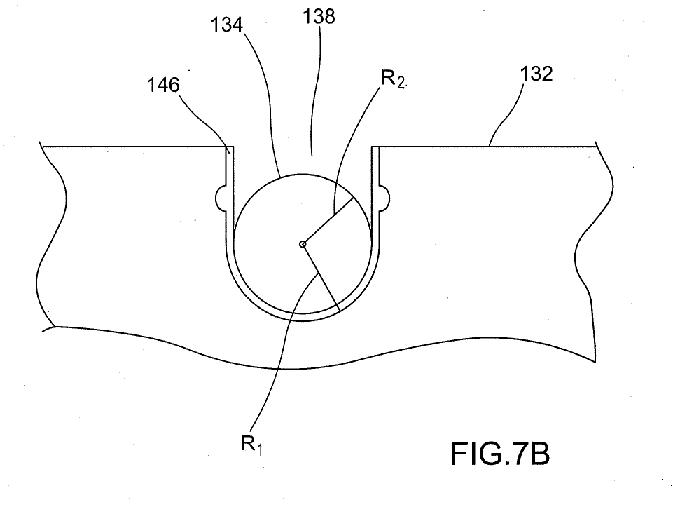

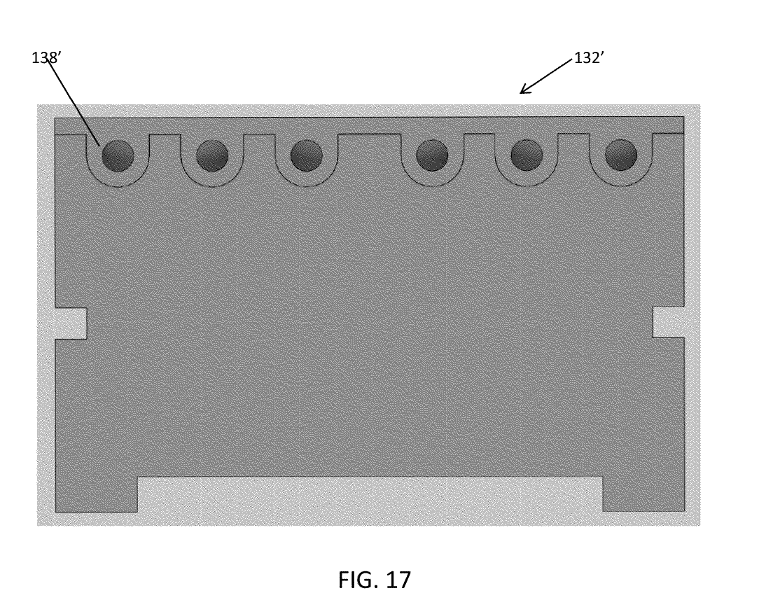

As shown in FIGS. 4 and 5, the sublimation crucible 132 defines a channel 138 in a bottom surface 140 of the crucible 132. The channel 138 can be formed to have a shape that can matingly receive the heating element 134 therein, as described in more detail below. For example, the channel 138 can be a serpentine shape that wraps or curves five times (e.g., as shown in FIGS. 4 and 5A) and that can receive a corresponding serpentine shaped heating element 134 that wraps or curves five times (see, e.g., FIG. 7A). Although the channel 138 is shown as having the contour and cross-section as shown in FIGS. 4, 5A and 7B, in alternative embodiments, the crucible 132 can define a channel 138 having a variety of different cross-sections. For example, the crucible 132 can define a channel 138 having sharp interior corners rather than being radiused. In another example embodiment, FIG. 17 illustrates a cross-section of a crucible 132′ defining a channel 138′ having a different contour and cross-section than the channel 138.

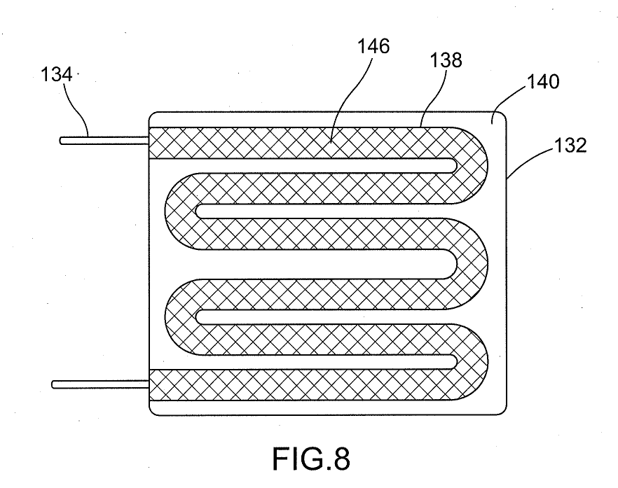

The crucible 132 also defines a first opening 142 and a second opening 144 defined in a side wall of the crucible 132 and in fluid communication with the channel 138 through which leads of the heating element 134 can extend when the heating element 134 is disposed within the channel 138 (see, e.g., FIGS. 3 and 8). The channel 138 can be formed with a mechanical cutting process, laser cutting, etc., as is known in the art Although in this embodiment, the crucible 132 defines a single continuous channel 138 that can receive a heating element 134, in other embodiments, the crucible 132 can include more than one channel 138 configured to receive a heating element 134. The crucible 132 can also define a channel 138 having a different shape than the serpentine shape of channel 138 shown in FIGS. 4 and 5A. For example, in some embodiments, the crucible 132 can define one or more straight or linear channels each configured to receive a corresponding straight or linear heating element. In some embodiments, the channel 138 can span multiple faces (or sides) of the crucible 132.

As described above, the shape of the channel 138 can be formed such that the heating element 134 (also referred to as a “heating coil” or “coil”) can be matingly received within the channel 138. For example, the channel 138 can have an inner contour (see e.g., FIG. 5B) that closely matches a cross-sectional outer perimeter of the heating element 134. The channel 138 can have a cross-sectional radius R₁ that is substantially the same or slightly larger than a cross-sectional radius R₂ of the heating element 134 (see, e.g., FIG. 7B). In some embodiments, the heating element 134 has a uniform cross-section along a length of the heating element 134. In some embodiments, the heating element 134 may have a cross-section that varies along a length of the heating element 134. For example, it may be desirable in certain circumstances to form the channel 138 deeper near a perimeter wall(s) in order to improve or control heat distribution into the side walls of the crucible 132. In such an embodiment, the heating element 134 may have a cross-section that varies to fit within the channel 138, while maintaining a uniform clearance to a wall of the channel 138. As described above, in some embodiments, more than one heating element 134 may be included in the evaporative deposition system 130. In such an embodiment having multiple heating elements 134, each heating element 134 be controlled by a single system controller, or each heating element 134 can be controlled separately to control the heat distribution through the crucible 132.

Many types of heating elements 134 can be used that can support the high temperatures present in this type of application (e.g., in an evaporative deposition system). In some embodiments, the heating element 134 is a nickel chromium (NiCr) coil. In some embodiments, the heating element 134 is a 1200 Watt NiCr 80 heater.

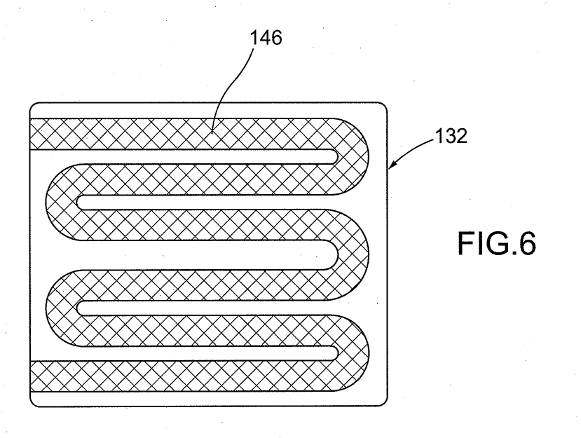

Because the crucible 132 is commonly composed of an electrically conductive material, it is desirable to electrically isolate the electric heating element 134 from the crucible 132. To electrically isolate the heating element 134 when disposed within the channel 138, a thermally conductive, electrically insulating material can be used to embed the heating element 134 within the channel 138. Specifically, a first layer of thermally conductive, electrically insulating material 146 (see, e.g., FIGS. 6 and 7B) can be formed on a surface of the channel 138 prior to inserting the heating element 134. The first layer of thermally conductive, electrically insulating material 146 can be, for example, a ceramic material. The first layer of thermally conductive, electrically insulating material 146 (also referred to herein as “first layer”) can be formed by pouring or injecting a first volume of the thermally conductive, electrically insulating material (also referred to herein as “first volume of material”) into the channel 138. With the first volume of material disposed within the channel 138, the crucible 132 can be agitated or shaken to remove or reduce any air bubbles that may be present in the first volume of material.

A mold (not shown) can then be pressed into the channel 138 such that the first volume of material forms the shape of the mold. The mold can have the same or substantially the same cross-sectional radius as the heating element 134. After the mold has been placed in the channel 138, the crucible 132 can be agitated or shaken again. After the first volume of material is cured (or sets) for a desired time period, the mold can be removed and the first volume of material will be formed into the first layer 146. It may be desirable for the first layer 146 to have a substantially uniform thickness such that the heat distribution between the first layer 146 and the heating element 134 is substantially consistent.

In some embodiments, the radius R1 of the channel 138 may not be substantially less than 2×R2 until the difference between R1 and R2 reaches approximately 0.125 inches, such that the thickness of the first layer of material 146 can be held at this thickness (i.e., 0.125 inches). In other words, the thickness of the first layer 146 can be half the thickness of the heater element 134. Thus, for a heater element 134 having a thickness or diameter of 0.25 inches, the first layer of material can have a thickness of 0.125 inches. In such an embodiment, the first layer of material 146 may be thick enough to mold the first layer of material 146, but sufficiently thin to allow good thermal conduction to the crucible 132. For example, in some embodiments, if the heater element 134 has a thickness or diameter of 0.5 inches, because the thickness of the first layer of material 146 is sufficient at 0.125 inches, it may be unnecessary for the thickness of the first layer of material 146 to be half the thickness of the heater element 134 in such an embodiment. In some embodiments, if the heater element 134 has a thickness or diameter of 0.125 inches, the first layer of material can have a thickness of 0.0625 inches. In such an embodiment, if the first layer of material 146 had a thickness of 0.125 inches, it may be unnecessarily thick and impede the flow of heat.

With the first layer 146 formed in the channel 138, the heating element 134 can then be placed within the channel 138 (see e.g., 7B) such that at least a portion of the first layer 146 is disposed between the heating element 134 and the surface of the crucible 132. After the heating element 134 has been disposed within the channel 138, a second volume of thermally conductive, electrically insulating material (also referred to herein as “second volume of material”) can be poured over the heating element 134 and into the channel 138 to embed the heating element 134 within the channel 138. The crucible 132 can again be agitated or shaken to eliminate or reduce any air bubbles present in the second volume of material. The second volume of material can then be allowed to cure or set to form a second layer of thermally conductive, electrically insulating material 148 (also referred to herein as “second layer”), as shown in FIG. 8. The cover 136 (shown in FIG. 3) can be placed over the second layer 148. In some embodiments, after the second volume of material has cured or set, the crucible 132 (with the heater element 132 and first and second layers of material 146 and 148) can undergo a thermal bake process to eliminate or reduce any remaining moisture that may be present in the material, and increase the strength of the material. The particular process to be applied can depend on factors such as the type of thermally conductive electrically insulating material being used.

Many types of materials may be used to provide the electrically insulating/thermally conducting layers 146 and 148 between the heating element 134 and the crucible 132. Selection criteria for the material can include factors, such as, for example, (1) similar thermal expansion properties to the crucible, (2) can bond well with the crucible, (3) must be electrically resistant, and (4) have fairly high thermal conductivity. In some embodiments, the selection process may include first identifying one or more materials that meet factors (1)-(3) listed above. If more than one material is identified, the material having the highest thermal conductivity may be selected. In some embodiments, the electrically insulating/thermally conducting layers 146 and 148 are formed with a Cotronics Resin Bond 920 ceramic potting compound, available from Contronics Corporation in Brooklyn, N.Y.

In some embodiments, prior to fabrication of the evaporative deposition system 100, computational fluid dynamics (CFD) thermal modeling can be used to optimize the location or locations for the channel 138 and the heater element 134 to provide for a desired temperature uniformity of the apparatus.

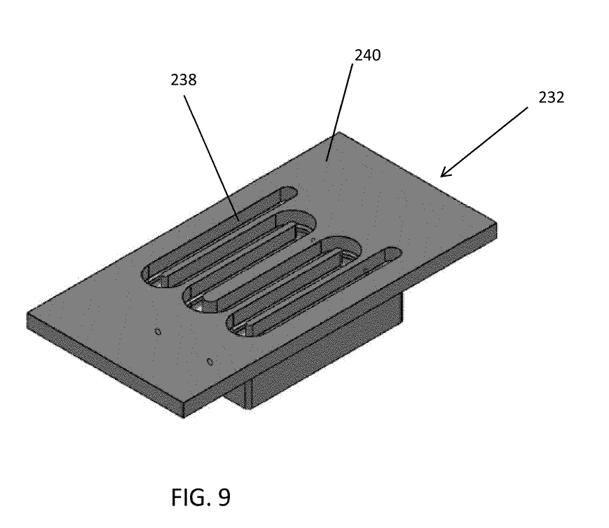

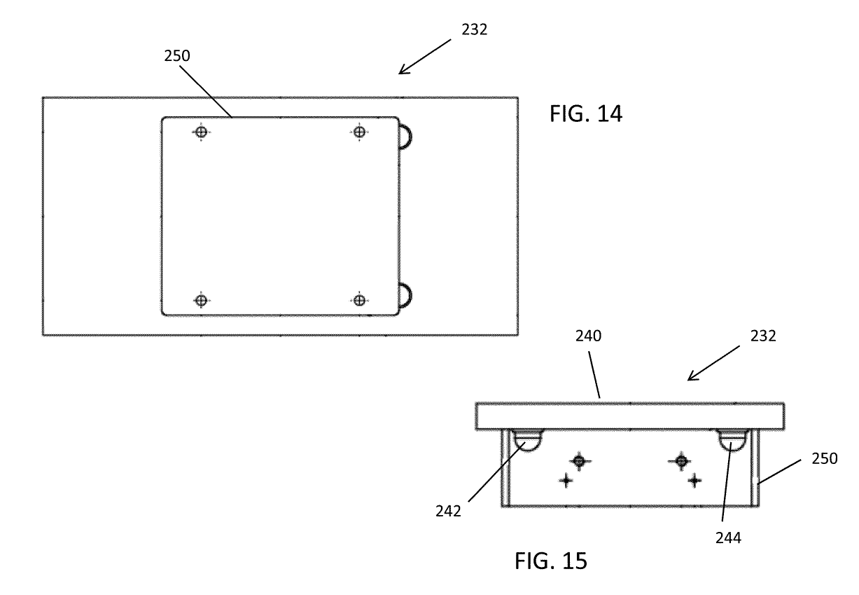

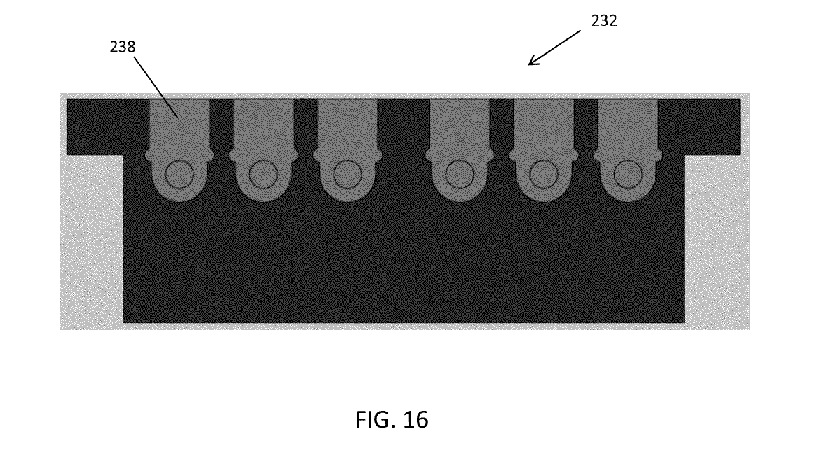

FIGS. 9-16 illustrate another embodiment of a sublimation crucible that includes a channel to receive and embed an electrical heating element (not shown) in a similar manner as described above. A sublimation crucible 232 can be formed with a material, such as, for example, graphite, and can be used in an evaporative deposition system in the same or similar manner as described above for previous embodiments.

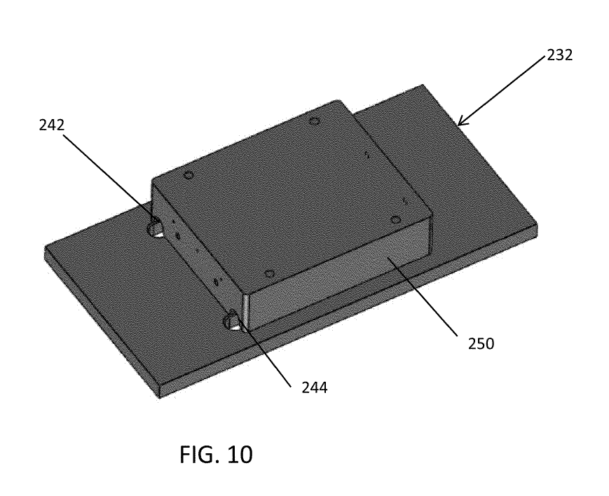

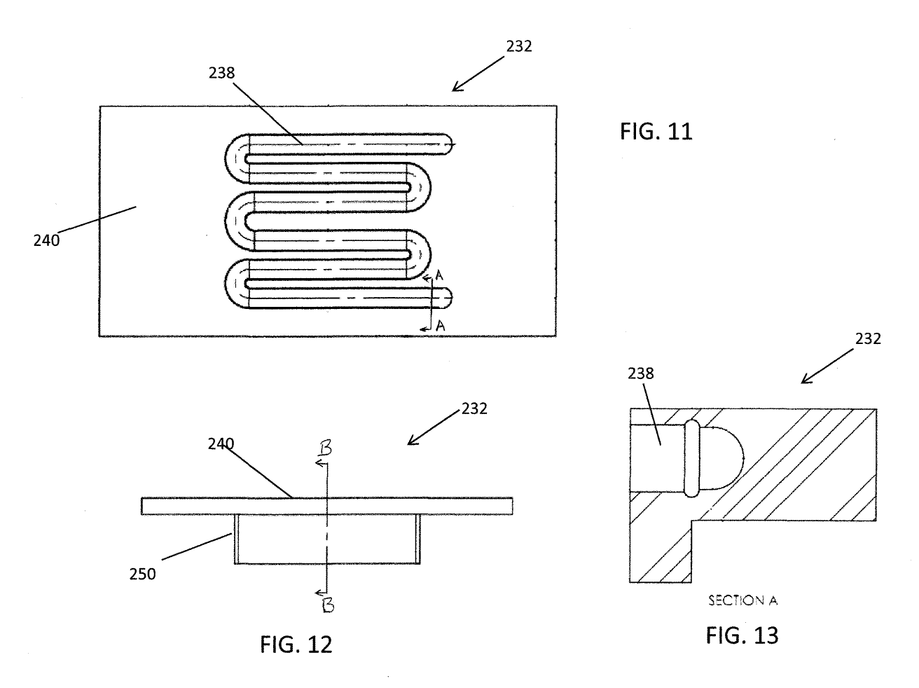

The sublimation crucible 232 defines a channel 238 in a bottom surface 240 of the crucible 232. The channel 238 can be formed to have substantially the same or the same shape as a heating element (not shown) such that the heating element can be received in the channel 238, as described above for crucible 132. As shown in FIGS. 9 and 11, the channel 238 can be a serpentine shape. The crucible 232 also defines a first opening 242 and a second opening 244 defined in a side wall of the crucible 232 and in fluid communication with the channel 238 through which leads of the heating element can extend when the heating element is disposed within the channel 238. In this embodiment, the openings 242 and 244 are defined on a top side portion 250 of the crucible 232 (see e.g., FIGS. 10 and 15). The channel 238 can be formed with a mechanical cutting process, laser cutting, etc., as is known in the art.

As described above for evaporative deposition system 130, the shape of the channel 238 can be formed to be substantially the same as the shape of the heating element such that the heating element can be received within the channel 238. To electrically isolate the heating element when disposed within the channel 238, a thermally conductive, electrically insulating material can be used to embed the heating element within the channel 238 in the same or similar manner as described above for evaporative deposition system 130.

In an alternative embodiment, an evaporative deposition system or substrate heater can include an embedded heater element as described herein that is coupled to the crucible or substrate without the use of a channel. In such an embodiment, a first volume of thermally conductive, electrically insulating material can be disposed on a flat surface of the crucible or substrate forming a first layer as described herein, and a heater element can be placed on top of the first layer of material. A second volume of thermally conductive, electrically insulating material can be disposed over the heater element to isolate the heater element from the crucible or substrate. Further, as described above, in some embodiments, a substrate heater can include an electrical heater element embedded within a channel formed within the substrate using a thermally conductive, electrically insulating material in a similar manner as described herein for embodiments for an evaporative deposition system.

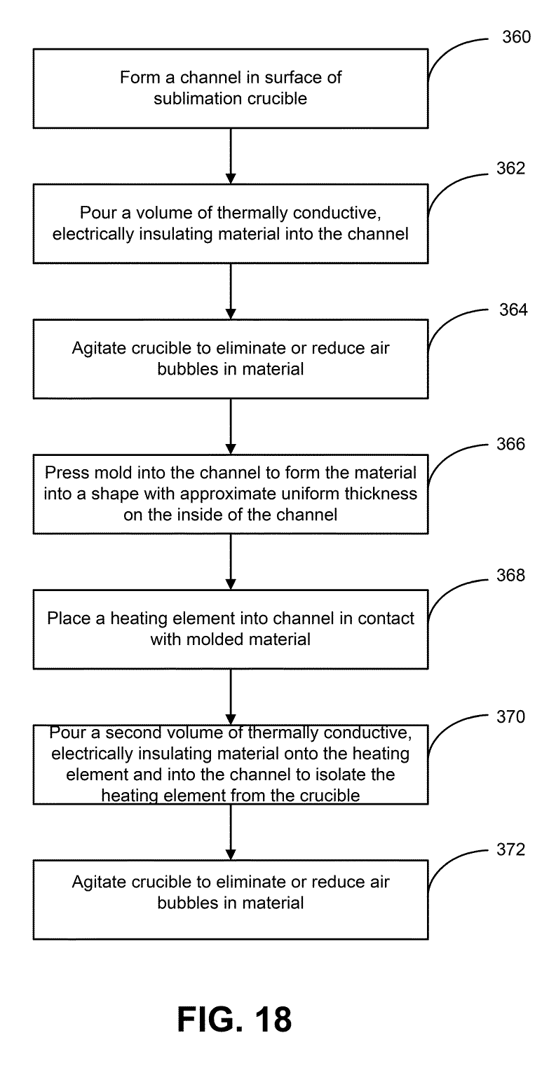

FIG. 18 is a flowchart illustrating a method of making a sublimation crucible to be used in an evaporative deposition system according to an embodiment. At 360, a channel (e.g., 138, 238) is formed in a surface of a sublimation crucible (e.g., 132, 232). For example, a channel is cut in a bottom surface of the crucible. In some embodiments, the channel can have a serpentine shape. A portion or volume of thermally conductive, electrically insulating material is poured into the channel at 362. The thermally conductive, electrically insulating material can be for example, a ceramic material as described herein. At 364, the crucible can be agitated or shaken to eliminate or reduce any air bubbles that may be present in the thermally conductive, electrically insulating material. At 366 a mold is pressed into the channel to form the thermally conductive, electrically insulating material into a shape with approximate uniform thickness on the inside of the channel of the crucible. The material can then be allowed to cure or set for a desired time period. The mold can then be removed from the channel In some embodiments, prior to taking the mold out of the channel, the crucible can be agitated again. At 368, a heater element (e.g., 134), such as an electrical heating coil, is placed into the channel in contact with the molded thermally conductive, electrically insulating material. At 370, a second portion or volume of thermally conductive, electrically insulating material is then poured onto the heating element and into the remaining portions of the channel to isolate the heating element from the crucible. At 372, the crucible can then be agitated or shaken again to eliminate or reduce any air bubbles that may be present. The second volume of thermally conductive, electrically insulating material can be allowed to cure or set for a desired time period. In some embodiments, the crucible (with the heater element and first and second volumes of material) can undergo a thermal bake process to eliminate or reduce any remaining moisture that may be present and to strengthen the layers of material. As described above for previous embodiments, the thermally conductive, electrically insulating material can embed the electrical heating element in the channel of the crucible and electrically isolate the heating element from the crucible during operation of the evaporative deposition system.

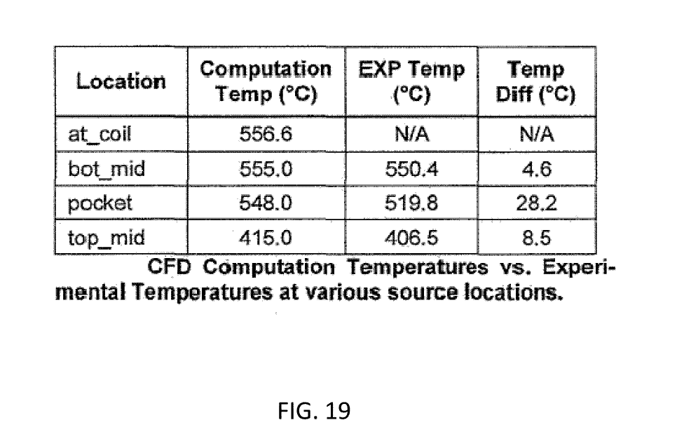

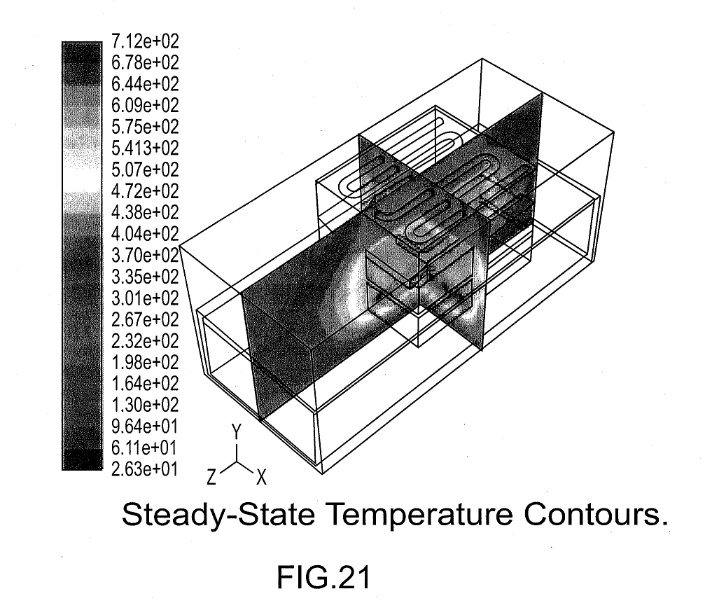

FIGS. 19-21 illustrate the results of example tests of a crucible using an embedded heat source as described herein. Specifically, a coiled NiCr wire heating element was embedded into the graphite crucible and used to facilitate the conductive heating of the crucible. As described above, this arrangement allows direct conduction into the crucible, improving energy use and permitting better temperature uniformity throughout the crucible. In this example, the heating coil was made from NiCr 80 resistive heating wire that was designed to output 1,200 W at 120 VAC. A castable, electrically insulating, alumina based ceramic was used to embed the NiCr coil in a machined serpentine groove at the bottom of the graphite crucible. The whole unit was then installed in stainless steel racking and topped with a graphite substrate heater using the same embedded heating element (see, e.g., FIG. 21).

Computational fluid dynamics (CFD) thermal modeling was used to evaluate the thermal gradients within the graphite crucible and to determine heating uniformity and maximum temperature (see, e.g., FIG. 19, temperatures measured at coil, bottom middle, pocket and top middle of crucible). Due to the complexity of the coiled heating wire the heating was modeled by applying a flux of 72.5 kW/m² to the cylindrical surface of the outside diameter of the heating coil. This heat flux equates to 1200 W over the whole surface area of the modeled heating coil surface. An initial 2D model of only the main crucible without racking shielding or top source was created to predict thermal uniformity and steady state temperature. The initial results showed acceptable temperature uniformity in the horizontal plane of the design and predicted a steady state temperature in the sublimation pocket of 525° C. Subsequent testing of a prototype heating unit matched the steady state temperature within 5° C.

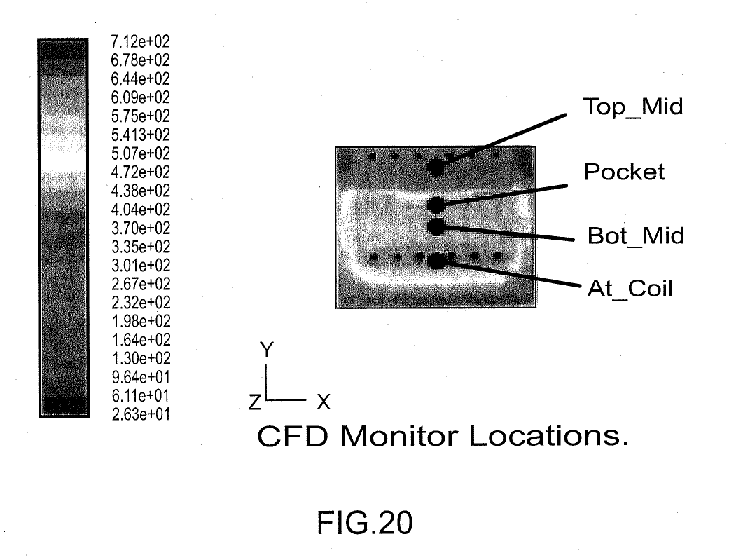

A full 3D thermal model and a prototype of the sublimation unit were then created. To accurately model the unit at operating conditions, the top heater was set to a steady operating temperature of 400° C., which is the typical operating temperature of the top heater. The main bottom heating unit was given the same heat flux to emulate a 1200 W heater. Point surfaces were created in the CFD model to monitor temperature at approximately the same locations as thermocouples in the prototype test (see FIG. 20, monitor locations at top middle, pocket, bottom middle and at coil).

The initial CFD run had steady state temperatures 19-20° C. higher than the actual experimental data. This was caused by using the theoretical heat output of the heating: coil. The actual voltage and resistance of the heater were significantly lower than expected. The actual heat output of the heating coil was found to be 1,121 W. The CFD model was then re-evaluated with the actual heat flux. Comparison of both indicates that the steady state temperatures matched the experimental data within 10° C. (see FIG. 19). The temperature discrepancy at the pocket location is due to poor placement of the thermocouple during prototype testing. The CFD model's ability to match the steady state temperatures of experimental data verifies that it is useful in design analysis. Thus, CFD modeling can be used to investigate the internal temperature uniformity in the crucible. From the plot of contours of steady state temperature (see FIG. 21), we can see that the core temperature around the sublimation pocket is a steady temperature of approximately 550° C. and has good temperature uniformity in the horizontal plane.

Thermal modeling shows that the new heating design can reach desired operating temperature and maintain good temperature uniformity throughout the horizontal plane of the crucible. The new design is expected to utilize less energy than typical IR bulb heating schemes.

In conclusion, the present invention provides, among other things, an evaporative deposition system that includes as the heat source an electrical heater coil embedded within the crucible and a method for making such an evaporative deposition system. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. An apparatus, comprising:
a base member defining a channel in a surface of the base member, the base member configured to be used as a sublimation crucible;
a first layer of electrically insulating material disposed within the channel, the first layer of electrically insulating material having a substantially uniform thickness;
a heating element disposed within the channel such that at least a portion of the first layer of electrically insulating material is disposed between the heating element and the surface of the base member; and
a second layer of electrically insulating material disposed on the heating element such that the heating element is disposed between the first layer of electrically insulating material and the second layer of electrically insulating material.

2. The apparatus of claim 1, wherein the base member is formed with a graphite material.

3. The apparatus of claim 1, wherein the first layer of electrically insulating material is a ceramic material and the second layer of electrically insulating material is a ceramic material.

4. The apparatus of claim 1, wherein the channel has a serpentine shape.

5. The apparatus of claim 1, wherein the channel has a cross-sectional radius substantially the same as a cross-sectional radius of the heating element.

6. The apparatus of claim 1, wherein the heating element is an electrical heating coil.

7. A method, comprising:
forming a channel in a surface of a sublimation crucible;
pouring a first volume of electrically insulating material into the channel;
pressing a mold into the channel such that the first volume of electrically insulating material forms a shape of the mold;
placing a heater coil into the channel such that the molded electrically insulating material is disposed between surface of the sublimation crucible and the heater coil; and
pouring a second volume of the electrically insulating material over the heater coil such that a layer of the second volume of electrically insulating material is formed over the heater coil.

8. The method of claim 7, further comprising:
after the pouring, agitating the sublimation crucible.

9. The method of claim 7, wherein the electrically insulating material is a ceramic material.

10. The method of claim 7, wherein the pressing the mold includes pressing the mold such that the shape of the first volume of electrically insulating material has substantially the same cross-sectional radius as a cross-sectional radius of the heater coil.

11. The method of claim 7, wherein the pressing the mold includes pressing the mold such that the first volume of electrically insulating material has a substantially uniform thickness.

12. The method of claim 7, further comprising:
after the pouring the second volume of electrically insulating material, agitating the sublimation crucible; and
curing the second volume of electrically insulating material for a selected time period.

13. The method of claim 7, further comprising:
after the pressing a mold into the channel, curing the first volume of material for a selected time period; and
removing the mold from the channel.

14. An apparatus, comprising:
a base member formed with a graphite material, the base member configured to be used as a sublimation crucible in an evaporative deposition system,
the base member defining a channel in a surface of the base member, the channel having a shape and a cross-sectional radius configured to receive a heating element therein having substantially the same cross-sectional radius and substantially the same shape as the channel,
the base member defining a first opening and a second opening each in fluid communication with the channel and configured to receive therethrough a portion of the heating element when disposed within the channel.

15. The apparatus of claim 14, wherein the channel has a serpentine shape.

16. The apparatus of claim 14, wherein the heating element is an electrical heating coil.
